(19) United States
(12) Patent Application Publication
(10) Pub. No.: US 2005/0183561 A1
(43) Pub. Date: Aug. 25, 2005

(54) Rotational cutting blades assembly for wood chopper

(76) Inventor: Yu-Chao Chao, Chang-Hua Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/033,291

(22) Filed: Jan. 12, 2005

(30) Foreign Application Priority Data
Feb. 20, 2004 (TW) 093202533

(51) Int. Cl. B26D 5/20; B26D 1/12

(52) U.S. Cl. 83/659; 83/356.3; 83/835

(57) ABSTRACT

A rotational cutting blades assembly for wood chopper is disclosed. It mainly comprises a rotational shaft, several blade seats, and several cutting blades. Each blade seat has an inner edge, an outer edge, a fixing hole near its inner edge, and a debris guiding recess disposed on the outer edge. This blade seats are fixed on the shaft and alternatively separated each other. Concerning this invention, it is easy to replace or to repair it. The blade life can be prolonged. The debris guiding is smooth. And, the power consumption is less.

### BACKGROUND OF INVENTION

1. Field of the Invention

The present invention relates to a rotational cutting blades assembly for wood chopper. Particularly, it relates to rotational cutting blades assembly for wood chopper that has alternately separated blades seats. Regarding this invention, it is easy to replace or to repair it. The blade life can be prolonged. The debris guiding is smooth. And, the power consumption is less.

2. Description of the Prior Art

Traditionally, for most abandoned wood (or bush wood, tree branches, etc.), if it can be chopped into small pieces or debris, it will be easier to make further processing or recycling. For example, the debris can be used for burning or to be treated as an organic fertilizer, and so on. But, if a person uses an electric saw to cut the wood, this wood only can be cut into lager pieces. If the person uses an axe to cut it, it is hard to cut into smaller pieces. Therefore, it is difficult to cut or chop the abandon wood into smaller pieces or debris.

In addition, the traditional electric saw usually has a plurality of cutting edges on its saw blade. If one or two cutting edges are worn out or broken, the entire saw blade should be abandoned. It is just a waste.

### SUMMARY OF THE INVENTION

The primary object of the present invention is to provide a rotational cutting blades assembly for wood chopper. Because one of its blade seats can be detached and replaced, it is easy to replace or to repair it.

The next object of the present invention is to provide a rotational cutting blades assembly for wood chopper. The blade life can be prolonged.

The other object of the present invention is to provide a rotational cutting blades assembly for wood chopper. The debris guiding is pretty smooth.

Another object of the present invention is to provide a rotational cutting blades assembly for wood chopper. The power consumption is less.

In order to achieve above-mention objects, a technical solution is provided below.

A rotational cutting blades assembly for wood chopper, comprising
a rotational shaft;
a plurality of blade seats, each blade seat having a predetermined width and having an inner edge, an outer edge, a fixing hole near said inner edge, and a debris guiding recess disposed on said outer edge, said fixing hole being to mount said blade seat on said shaft, a blade holding portion being disposed on said outer edge near said debris guiding recess; and, said blade seats being fixed on said shaft and alternately separated each other;
a plurality of cutting blades mounted on said plurality of blade holding portions respectively, each cutting blades has a predetermined thickness, each of said cutting blades having a cutting edge, all distances between said cutting edges and said shaft being substantially equal.

### BRIEF DESCRIPTION OF THE DRAWINGS

FIG. 1 is a perspective view of the present invention;

FIG. 2 is a side view of the present invention;

FIG. 3 is a perspective view of the cutting blade;

FIG. 4 is a side view when this invention is cutting a wood; and

FIG. 5 is a top view when this invention is cutting a wood.

### DETAILED DESCRIPTION OF THE PREFERRED EMBODIMENT

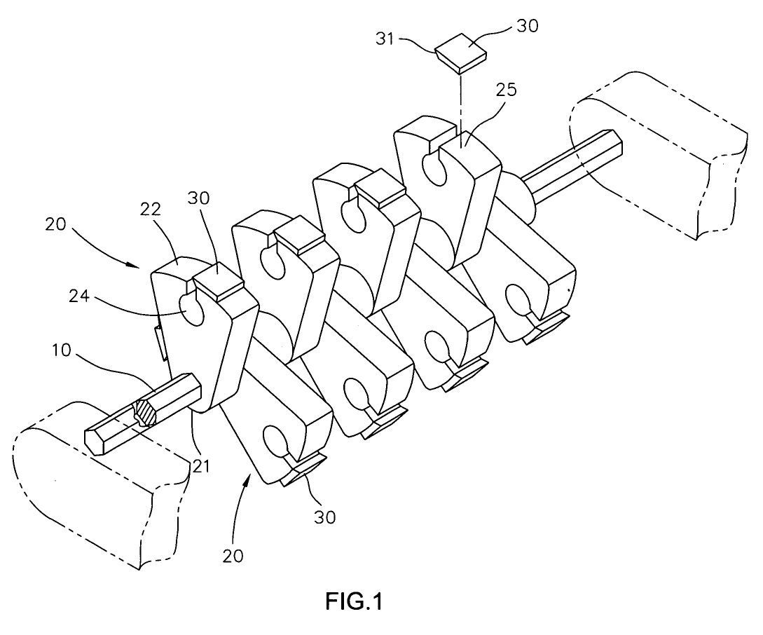

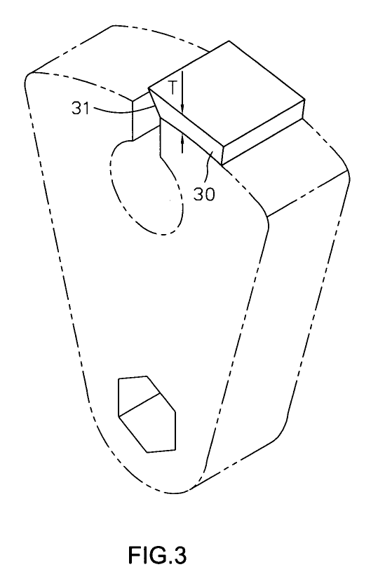

Referring FIGS. 1 and 3, the present invention is a rotational cutting blades assembly for wood chopper. It mainly comprises a shaft 10, a plurality of blade seats 20, and a plurality of cutting blades 30.

With regard to the rotational shaft 10, its cross-sectional shape could be hexagonal, octagonal, or polygonal. Or, the shaft 10 has a key recess (not shown) for cooperating with a key (not shown).

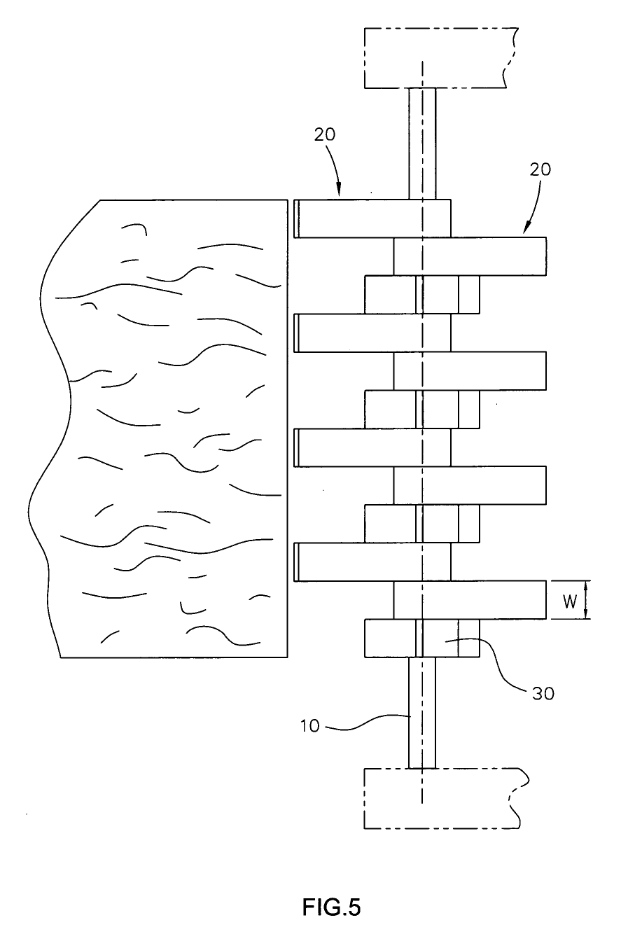

Concerning these blade seats 20, each blade seat 20 has a predetermined width W (as shown in FIG. 5) and has an inner edge 21, an outer edge 22, and a fixing hole 23 near the inner edge 21. A debris guiding recess 24 disposed on the outer edge 22. The fixing hole 23 is to mount the blade seat 20 on the shaft 10. A blade holding portion 25 (such as a welding portion) is disposed on the outer edge 22 near the debris guiding recess 24. And, the blade seats 20 are fixed on the shaft 10 and alternately separated each other.

In this embodiment, there are twelve blade seats 20 separating by 120 degrees alternately. One of the blades seats 20 and its adjacent blade seat 20 are disposed apart by a substantially 120 degrees therebetween about their extending directions from the shaft 10. Therefore, the first, fourth, seventh, and tenth blade seats are fixed at the angle of zero degree. The second, fifth eighth, and eleventh blade seats are fixed at the angle of 120 degrees. And, the third, sixth, ninth, and 12th blade seats are fixed at the angle of 240 degrees. Of course, they can be designed by alternate 90 degrees apart or by other specific separating angles.

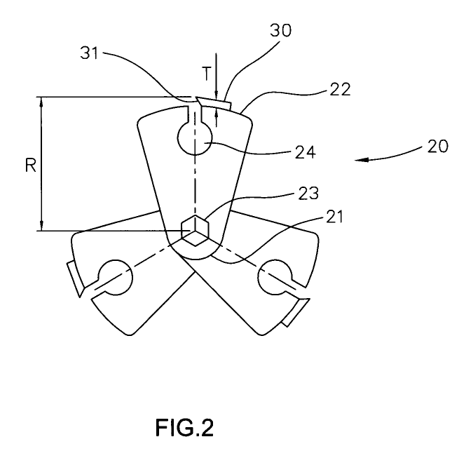

About these cutting blades 30, they are mounted on the plurality of blade holding portions 30 respectively. Each cutting blades 30 has a predetermined thickness T (as shown in FIGS. 2 and 3). Each of said cutting blades 30 has a cutting edge 31. All distances R (shown in FIG. 2) between the cutting edges 31 and the shaft 30 are substantially equal.

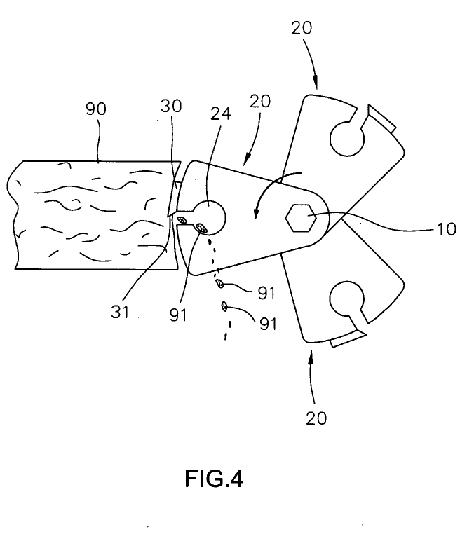

Referring to FIGS. 4 and 5, they show the actual operation of this invention. First, the rotational shaft 10 rotates and approaches to a wood 90 to be chopped. When the cutting edge 31 of the cutting blade 30 cuts the wood 90 (or bush wood and the like), due to the fixed thickness T of the cutting blade 30, its cutting depth into the wood 90 is kept constant. It will not cut too thick or too thin. Thus, the sizes of all debris 91 are roughly same. In addition, because there is a unique smoothly-shaped debris guiding recess 24, the cut debris 91 will follow the curved surface of the debris guiding recess 24 and then will smoothly move away (beside the cutting blade) and drop down (or fall down). Thus, the entire debris guiding process is very smooth.

Moreover, as illustrated in FIG. 5, these twelve cutting blades 30 can be classified into three groups (for alternately cutting). So, the wearing of cutting blades 30 are more evenly and feeding action will be more smoothly. Hence, the life of all these cutting blades 30 can be raised.

If a specific cutting blade 30 is worn out or one blade seat 20 is broken, this specific blade seat 20 can be detached out and just replace a new one (with a new cutting blade) individually. On the other hand, only the broken one needs to be replaced or repaired. There is no need to replace the entire set of cutting blades assembly.

Therefore, the advantages and functions of this invention can be summarized as follows:
[1] It is easy to replace or to repair it. Because each blade seat can be taken out and be replaced, it is very easy to replace a new one or to repair it.
[2] The blade life can be prolonged. In this invention, all these cutting blades are mounted on the alternately-separated blade seats with certain angle, so the contacting times and positions of the cutting points/areas are alternate and evenly distributed. Thus, the blade life can be prolonged.
[3] The debris guiding is smooth. Because the thickness of every cutting edge is the same, the thickness will be the same theoretically. Plus, there is a debris guiding recess to enhance the cut debris to move out and drop down (along both sides of the blade seat). So, the debris guiding process is very smooth.
[4] The power consumption is less. Due to the special arrangement for the alternate blade seats, while it is feeding, the feeding resistance force is less. Therefore, its power consumption is less.

The above embodiments are only used to illustrate the present invention, not intended to limit the scope thereof. Many modifications of the above embodiments can be made without departing from the spirit of the present invention.

1. A rotational cutting blades assembly for wood chopper, comprising:
a rotational shaft;
a plurality of blade seats, each blade seat having a predetermined width and having an inner edge, an outer edge, a fixing hole near said inner edge, and a debris guiding recess disposed on said outer edge, said fixing hole being to mount said blade seat on said shaft, a blade holding portion being disposed on said outer edge near said debris guiding recess; and, said blade seats being fixed on said shaft and alternatively separated each other; and
a plurality of cutting blades mounted on said plurality of blade holding portions respectively, each cutting blades has a predetermined thickness, each of said cutting blades having a cutting edge, all distances between said cutting edges and said shaft being substantially equal.

2. The rotational cutting blades assembly for wood chopper as claimed in claim 1, wherein a cross-sectional shape of said shaft is polygonal.

3. The rotational cutting blades assembly for wood chopper as claimed in claim 1, wherein one of said blades seats and its adjacent blade seat are disposed apart by a substantially 120 degrees therebetween about their extending directions.
